(19) United States
(12) Patent Application Publication
(10) Pub. No.: US 2009/0311477 A1
(43) Pub. Date: Dec. 17, 2009

(54) Compliant Substrate In Particular For Hetero-Epitaxial Depositing

(76) Inventors: Bernard ASPAR, Rives (FR); Michel BRUEL, Vevrey (FR); Eric JALAGUIER, Saint Martin D'uriage (FR); Hubert MORICEAU, St. Egreve (FR)

Correspondence Address: Nixon Peabody LLP, P.O. Box 60610, Palo Alto, CA, 94306, US

(21) Appl. No.: 12/544,202

(22) Filed: Aug. 19, 2009

Related U.S. Application Data
(63) Continuation of application No. 09/600,590, filed on Jul. 19, 2000, now abandoned.

(30) Foreign Application Priority Data
Jan. 30, 1998 (FR) 98/01061
Jan. 29, 1999 (FR) PCT/FR99/00187

(51) Int. Cl. B32B 3/00; B32B 15/00

(52) U.S. Cl. 428/141; 428/457

(57) ABSTRACT

The invention relates to a compliant substrate (5) comprising a carrier (1) and at least one thin layer (4), formed on the surface of the carrier and intended to receive, in integral manner, a stress-giving structure. The carrier (1) and the thin layer (4) are joined to one another by joining means (3) such that the stresses brought by said structure are absorbed in whole or in part by the thin layer (4) and/or by the joining means (3) which comprise at least one joining zone chosen from among the following joining zones: a layer of microcavities and/or a bonding interface whose bonding energy is controlled to permit absorption of said stresses.

### TECHNICAL FIELD

This invention relates to a compliant substrate, that is to say a substrate able to accept stresses induced by a structure adhering to it, and which may be a layer deposited on a surface of this substrate by hetero-epitaxy such that this layer suffers the least possible stress. It also relates to processes for obtaining such substrates.

### PRIOR ART

Electronic and optoelelectronic applications demand a growing number of semiconductor materials and in particular compound semiconductors such as, for example, those of III-V type. However, at the present time it is only known how to fabricate solid substrates for certain semiconductors such as silicon, gallium arsenide, silicon carbide and indium phosphide for example. For other semiconductors, the solution chosen is hetero-epitaxial growth on a substrate whose crystalline network is adapted to that of the semiconductor layer which is to be grown.

However, this constraint of having to adapt lattice parameters at the interface of growth between layer and substrate severely limits the number and diversity of layers which may be grown, as it is only rarely possible to find a substrate whose network is adapted to the desired layer. Hence, for example, no solid substrates exist which are perfectly adapted to the hetero-epitaxial growth of GaN, AlN and InN.

The use of ill-adapted substrates leads to the growth of layers of very poor quality. In particular, as soon as the thickness of the layer exceeds a critical value, which decreases the more the networks are ill-adapted, the stresses are released in the hetero-epitaxial layer through the creation of structure defects (dislocations in particular).

To overcome these problems, specialists in epitaxy on thick substrates have used growth techniques which include the fabrication of a stack of buffer layers whose purpose is to allow absorption of the stresses induced by the differences in lattice parameter between the substrate and the epitaxied layer, chiefly in the plane of epitaxy, and by the differences in thermal dilatation coefficients between the two materials. In this latter case, the temperature at which the epitaxied layer is grown is also a parameter which has to be taken into account. This stack of buffer layers ends in a superficial layer which is therefore used to germinate the epitaxied layer which is the desired layer. However, even using all this know-how, the materials obtained always contain crystalline defects and are frequently of insufficient quality to fabricate optoelectronic and/or electronic devices.

To remedy this problem, various studies on compliant substrates have been conducted. By way of example, mention may be made of the article “New Approach to Grow Pseudomorphic Structures over the Critical Thickness” by Y. H. LO, published in the journal Appl. Phys. Lett. 59 (18), 28 Oct. 1991. In this area, the compliant substrate is in essence a crystalline substrate whose crystalline lattice (lattice parameter) is not necessarily adapted to the layer it is desired to grow, but which, when the hetero-epitaxial layer is grown, has the property of relaxing the stresses related to growth of the layer, in the compliant substrate itself or at the interface, instead of allowing the stresses to relax in the hetero-epitaxial layer. In this way hetero-epitaxial layers of very high quality are obtained and, in principle, the compliant substrate allows growth of any type of layer on a crystalline network.

The fabrication of compliant substrates can be classified in three groups.

One first group relates to a very fine substrate (a few nm) that is self-supporting, which is very difficult to produce and even virtually impossible if it is required to obtain large surface areas. In this respect, reference may be made to the article: “Lattice Engineered Compliant Substrate for defect-free Hetero-epitaxial Growth” by F. E. EJECKAM et al., published in the journal Appl. Phys. Lett. 70 (13), 31 Mar. 1997.

A second group relates to a SOI structure (Silicon-On-Insulator) on a substrate. In this case, the superficial film obtained is very thin and the underlying insulator layer is likely to undergo deformation under the effect of the temperature during growth of the thin film.

A third group relates to a structure of a so-called “twist bonding” type. In this case, the thin film, allowing stress relaxation, subsequently called compliance, is made by means of bonding, through molecular adhesion, two crystalline substrates of same type, whose crystalline networks are disoriented, and by thinning one of the substrates until only a very thin layer subsists. In this respect, reference may be made to the article: “Dislocation-free InSb Grown on GaAs Compliant Universal Substrates” by F. E. EJECKAM et al., published in the journal Appl. Phys. Lett. 71 (6), 11 Aug. 1997. This bonding with disorientation induces, in the vicinity of the interface, the formation of dislocations which are found in the thinned layer, making the latter able to accommodate the stresses when a hetero-epitaxial layer is grown above it.

These compliant substrates of the prior art have certain limitations in use. For the self-supporting film, the limitation resides in the difficulty or virtual impossibility to produce a film of a few nm on a surface of several mm², and even more so, several dozen cm². No material exists at these thicknesses that is sufficiently rigid for handling. For the SOI structure, the limitation resides in the imperfect compliance of the substrate. This is related to the capacity of the insulator to deform (even creep) in order to absorb stresses. To achieve this result, recourse must be made to heat treatments at high temperatures and/or to adapted compositions (for example B and P doping for insulators of SiO2 type). These heat treatments are not always compatible with the layer to be epitaxied. For the third group of substrates, the difficulty is to obtain defect-free bonding over a large surface and to thin the layer down to a very narrow thickness. Also, this technique requires very good control over the crystalline disorientation between the two substrates if it is desired to properly control the number and type of dislocations which impart the compliant nature to this type of structure.

It is also known that an intimate bond between two materials may be obtained by molecular adhesion. Several cases may be encountered in relation to the endings present on the surface at the time of bonding. For example the terms hydrophilic or hydrophobic bonding are used.

Surface hydrophilia is generally obtained by means of chemical cleaning whose objective is to saturate the surface in OH hydroxyl groups (for silicon, for example, a surface density of 4.6/nm²). Water molecules can then adsorb naturally on these sites. The contacting of the two surfaces thus prepared leads to their adhesion with significant bonding energy (0.1 J/m² for silicon oxide/silicon oxide bonding) even at room temperature. Subsequent heat treatments allow its reinforcement owing to the development of the bonds present at the interface. Therefore, for SiO₂—SiO₂ bonding, heat treatments at low temperature, typically less than 300° C., bring the two surfaces together via hydrogen bonds between vis-à-vis hydroxyl groups via the onset of initial Si—O—SI bonds. Bonding energy therefore increases regularly with temperature to reach a bonding energy of 2 J/m² at 900° C.

On the contrary, for hydrophobic bonding (that is to say bonding which does not involve water molecules or hydroxyl groups), the surfaces are generally stripped before bonding in order to remove any native oxide. The cleaning used for stripping leaves the surfaces mainly saturated in Si—H endings, for silicon for example. Bonding resistance is only assured by an attraction of Van der Waals type and the bonding energies measured at room temperature for silicon-silicon bonding (approximately 10 mJ/m²) well relate to the theoretical calculation. With temperature rise, Si—Si bonds are formed by reconstruction of the two contacted surfaces.

This bonding mechanism may occur for the majority of materials provided that their roughness and planarity are sufficiently low. These two methods used well demonstrate that it is possible to control bonding forces between the different contacted materials in relation to surface treatment, applied heat treatments and surface roughness. One example of the development of this bonding energy is given in the article: “Mechanism for Silicon Direct Bonding” by Y. BACKLUND et al., published in the journal J. Micromech Microeng. 2 (1992), pages 158-160 (see FIG. 1 in particular). This bonding energy is determined by a method which uses the propagation of a crack at the bonding interface under the effect of the insertion of a blade at the bonding interface and parallel to this interface.

As early as 1989, some authors mentioned the possibility of using molecular adhesion to produce bonding between a multilayer film of GaAs/InGaAs/GaAs, previously made on a substrate well adapted to this structure, and an oxidized silicon carrier. Specific surface preparation enables low bonding forces to be obtained. In this respect, reference may be made to the article: “Characterization of Thin AlGaAs/InGaAs/GaAs Quantum-well Structures Bonded Directly to Si0₂/Si and Glass Substrates” by J. F. KLEM et al., published in the journal J. Appl. Phys. 66 (1), Jul. 1, 1989.

It is also known, for example through document FR-A-2 681 472, that implantation by bombardment of a rare gas or hydrogen in a semiconductor material, or in a solid material whether crystalline or not (cf. FR-A-2 748 850) is able to create microcavities or platelets at a depth close to the average depth of penetration of the implanted species. The morphology (size, shape . . . ) of these defects may change during heat treatments, in particular these cavities may have their size increased. Depending upon the type of material and especially depending upon its mechanical properties, these cavities may, according to the conditions of heat treatment, induce surface deformations called “blisters”. The most important parameters that need to be controlled in order to obtain such deforming are the dose of gas inserted during implantation, the depth at which the gas species are implanted and the heat schedule applied during implantation. By way of example, an implantation of hydrogen in a silicon wafer at a dose of 3.10¹⁶H⁺/cm², for an energy of 40 keV, creates a continuous embedded layer of microcavities that is approximately 150 nm thick, at an average depth of 330 nm. By continuous layer is meant a layer containing microcavities distributed in homogeneous manner over a certain thickness. These microcavities are of elongated shape (hence the name “platelets”). Their size is for example in the order of 6 nm in length and two atomic planes in thickness. If heat treatment is applied at 700° C. for 30 minutes, the microcavities magnify and their size may increase for example from 6 nm to over 50 nm in length and by a few atomic planes at 4-6 nm in thickness. On the other hand, no disturbance of the implanted surface is noted. Cavity size and the pressure within these cavities are not sufficient to induce surface deformation. This provides a continuous layer of embedded defects with a zone containing microcracks (or microcavities or platelets) but with no surface deterioration.

The presence of microcavities is also seen in the case of implantation made by helium bombardment at the average depth of implantation Rp in a substrate, for example in silicon. In this case, the cavities obtained are present even at annealing temperatures in the order of 1000° C. These defects cause strong, deep weaknesses in the material.

### DESCRIPTION OF THE DISCLOSURE

In order to remedy the disadvantages of the prior art, the present invention puts forward a compliant substrate which offers a thin layer of a material intended to be used to germinate hetero-epitaxial growth of another material. This thin layer is joined to the remainder of the substrate by joining means, which may be termed an embedded region, such that the thin layer and/or joining means accommodate all or part of the stresses caused during epitaxial growth of the epitaxied material, thereby preventing the occurrence of these stresses in the epitaxied material.

The compliant character of such a structure vis-à-vis a subsequently deposited material lies in the consideration given to differences in lattice parameter, thermal dilatation coefficients and the presence of the embedded region. By definition, the purpose of this compliant structure is to accommodate the stresses of the film of deposited material by relaxation thereof in the embedded region but possibly also in the thin layer.

One variant of the process consists of inserting a foreign element in the superficial thin film in order to modify the crystallographic parameters of the thin layer forming the germination film for epitaxy and consequently to change its stress state before epitaxial growth of the layer to be obtained.

It has also been found that such a compliant substrate may in its principle be used to absorb stresses due to causes other than growth of a material by epitaxy. In fact this compliant substrate may be used to receive any stress-giving structure.

The purpose of the invention is therefore a compliant substrate comprising a carrier and at least one thin layer formed on the surface of said carrier and intended to receive, in integral manner, a stress-giving structure, the carrier and the thin layer being joined one to another by joining means such that the stresses brought by said structure are absorbed in whole or in part by the thin layer and/or by the joining means, characterized in that said joining means comprise at least one joining zone chosen from among the following joining zones: a layer of microcavities and/or a bonding interface whose bonding energy is controlled to permit the absorption of said stresses.

The joining zone may be a layer of defects, for example a layer of microcavities. The layer of defects may be created by implantation through bombardment of one or more gas species. These gas species may be chosen from among rare gases, hydrogen and fluorine. Doping agents may be associated with the one or more gas species. It is also possible to conduct diffusion of the one or more implanted gas species. Implantation may be followed by heat treatment to enable the defects to develop. Implantation by bombardment may in particular be made via the substrate surface, the region lying between the substrate surface and the layer of defects providing said thin layer. Optionally, the region lying between the substrate surface and the layer of defects is thinned to form said thin layer. Implantation by bombardment may also be made through a sacrificial layer carried by said substrate surface, which said sacrificial layer can then be removed.

Implantation may be made via the substrate surface, this surface carrying a first thin layer, the region between the substrate surface and the layer of microcavities providing a second thin layer. The layer of microcavities may be made in the vicinity of the interface between the first thin layer and the substrate. Implantation by bombardment may be made via a sacrificial layer carried by the first thin layer, said sacrificial layer then being removed.

Bonding energy may be controlled by surface preparation and/or by heat treatment and/or through the creation of defects at this interface. These defects may, for example, be created through implantation by bombardment and/or by bonding defects. This creation of defects generally allows weakening of the bonding interface. Surface preparation may be control of roughness and/or of hydrophilia. Wafer roughness may be obtained by chemical attack with HF for example. Hydrophilia may be obtained by chemical cleaning of RCA type. The joining zone may also comprise at least one intermediate layer between the thin layer and the carrier. The intermediate layer may be made such that it is formed of non-homogeneities able to relax the stresses. By way of example, mention may be made of grain joints, growth lines, inclusions, etc. This layer may be etched on all or part of its surface. The intermediate layer may be a metal layer or a layer of a metal alloy.

The joining means may comprise a layer of microcavities and a bonding interface arranged either above or below the layer of microcavities.

In one privileged application, the thin layer is in a first crystalline material and is intended to serve as a seed for hetero-epitaxial growth of a second crystalline material forming said structure. This thin layer may be a layer that is pre-stressed through the insertion of a foreign element into said first crystalline material in order to promote the compliance of said substrate. The foreign body may be inserted through implantation by bombardment and/or inserted by diffusion. This implantation may be made via a sacrificial oxide. This foreign element may be a doping agent of the thin layer. The first crystalline material may in particular be a semiconductor, for example Si or GaAs. Such compliant substrate may advantageously be used for the hetero-epitaxial growth of a crystalline material chosen from among GaN, SiGe, AlN, InN and SiC.

### BRIEF DESCRIPTION OF THE FIGURES

The invention will be better understood and other advantages and special aspects will become apparent on reading the following description which is non-restrictive, accompanied by the appended drawings in which

FIGS. 1A to 1C illustrate a first example of embodiment of a compliant substrate of the present invention, the joining zone being a layer of microcavities;

FIGS. 2A to 2C illustrate a second example of embodiment of a compliant substrate of the present invention, the joining zone comprising a bonding interface;

FIG. 3 shows a compliant substrate of the present invention the joining zone comprising a bonding interface and an intermediate layer;

FIG. 4 shows a compliant substrate of the present invention, the joining zone comprising a bonding interface between two intermediate layers;

FIG. 5 is a diagram illustrating the development of bonding energy for Si0₂-SiO₂ bonding in relation to temperature and surface roughness.

### DETAILED DESCRIPTION OF EMBODIMENTS OF THE INVENTION

By way of preferred example, the remainder of the description shall relate to the fabrication of compliant substrates for the depositing of materials by hetero-epitaxy.

It is possible to obtain a film of narrow thickness from a substrate in which implantation of species is made (of ions for example) able to create, at a depth close to the average penetration depth of the species, a layer of defects which, between the substrate surface and itself, delimits a film of narrow thickness. The species are chosen such that the layer of created defects is able to accommodate the stresses to which the film of narrow thickness may be subjected. The role of the layer of defects is also to carry the film of narrow thickness (vertical action, perpendicular to the surface) while leaving it free of stresses in the horizontal plane (parallel to the surface). It may be necessary, in some cases, to apply heat treatment to the substrate after the implantation step so as for example to increase defect size, to cause the defects to coalesce in clusters of greater size, to modify their distribution to make the layer more adapted to stress accommodation.

Preferably species are chosen from among rare gases or hydrogen, or a combination of both, which are known to permit the creation of defects of microcavity type. In this case, a sufficient dose must be chosen to create these microcavities but lower than the critical dose above which implantation of species is likely to induce surface deformation of “blister” type. By way of example, in the case of silicon, it may be chosen to implant hydrogen ions at a dose of 3.10¹⁶/cm². However, it must be specified that this critical dose is related to implantation conditions and type of doping.

Film thickness is determined by the choice of implantation energy. In order to produce a very thin film (which is necessary to assure good compliance), a low implantation energy must be chosen. For example, in the case of silicon and hydrogen ions, an energy will preferably be chosen in the range of 1 keV to 10 keV, a range which enables films to be produced having a thickness of between 5 nm and 60 nm. It is also possible to obtain the required film thickness by thinning (polishing, chemical attack, sacrificial oxidation) a film obtained by implantation using energy that is greater than that which would have directly provided the required thickness.

In some cases, it may be advantageous to implant via a sacrificial layer, for example a layer of silicon oxide. In this case, it may no longer be necessary to use very low energies. The removal of the sacrificial layer may be sufficient to achieve a very thin superficial layer.

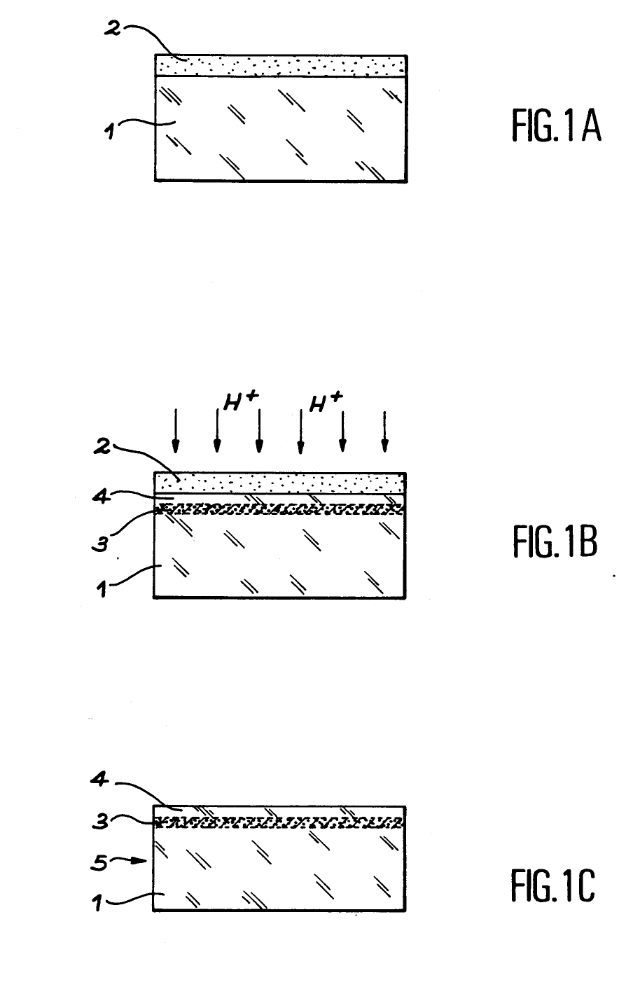

FIGS. 1A to 1C illustrate this last example. FIG. 1A, from side view, represents a substrate 1, in monocrystalline silicon for example, coated with a layer of silicon oxide 2 acting as sacrificial layer. FIG. 1B represents an ion implantation step, with hydrogen ions, of substrate 1 via oxide layer 2. Implantation is made under the conditions determined above. A layer 3 of microcavities or platelets is obtained determining a layer or thin film 4 adjacent to the oxide layer 2. On account of the presence of this oxide layer, the thickness of the thin layer 4 may be reduced and very precisely adjusted. The oxide layer 2 is then removed by chemical attack and compliant substrate 5 is obtained shown in FIG. 1C in which the assembly formed by the layer of microcavities 3 and the thin layer 4 (used as seed for a material to be epitaxied) forms a compliant layer. Optionally, heat treatment may be applied to increase the size of the microcavities of layer 3.

For some applications, ion implantation may also be made via two monocrystalline layers. A first monocrystalline layer, formed in the substrate itself, has a thickness between the substrate surface and the layer of microcavities induced by implantation. A second monocrystalline layer may be deposited on or transferred to the substrate. By way of example, the substrate chosen may be a structure made up of a thin layer of GaAs (for example 3 nm thick) transferred onto a silicon substrate using a method such as that described in document FR-A-2 681 472 associated with thinning by means of sacrificial layers. Subsequently, a sacrificial layer of silicon oxide is deposited on the structure in order to allow hydrogen implantation at the required depth. Hydrogen implantation in the silicon is made by crossing through the sacrificial oxide layer and the GaAs layer to create microcavities in the silicon but at a depth very close to that of the GaAs/Si interface, for example at a depth in the order of a few nm, even a few dozen nm. One variant of embodiment may consist of creating microcavities in the vicinity of the interface between GaAs and silicon.

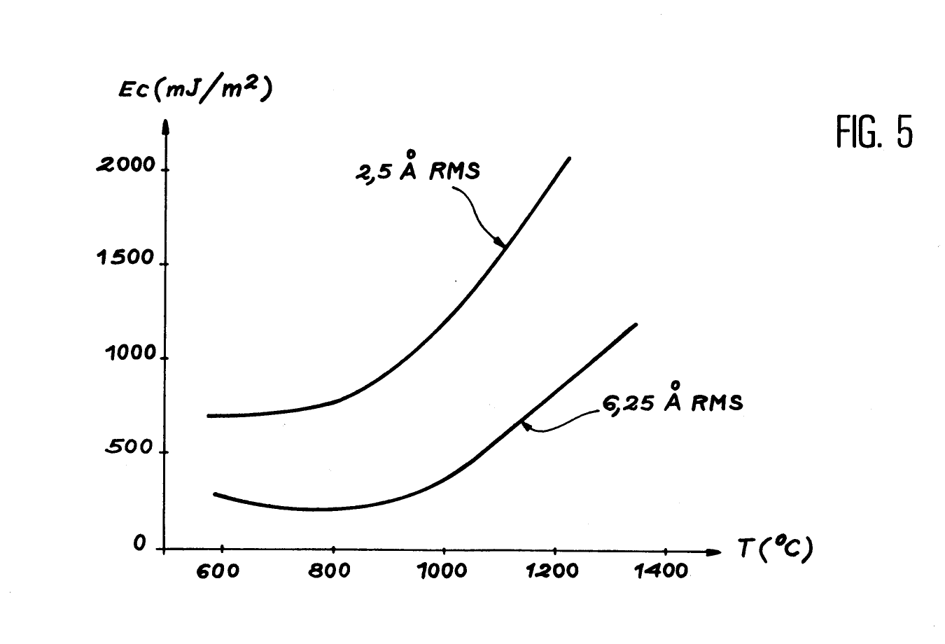

As indicated previously, the bonding forces are dependent upon numerous parameters (type of chemical species on the surface, heat schedule provided, initial surface roughness). However, these forces may be controlled so as to be able to control bonding energy. These bonding forces may then be accommodated in relation to the stress caused by the presence of a thin epitaxied layer of a material and induced by differences in lattice parameter, thermal dilatation coefficient, but also giving consideration to stresses induced by bonding through molecular adhesion itself. By way of example, for hydrophilic bonding of monocrystalline silicon wafers and using a method of fabricating a thin film of semiconductor material such as the one described in document Fr-A-2 681 472, it is possible to obtain a very thin layer of silicon (less than 10 nm) on an oxide layer of very narrow thickness (less than 5 nm). The originality in this case, compared with the process disclosed in document FR-A-2 681 472, lies in the final control of bonding forces, that is to say after fracture by annealing at low temperature (typically 450° C. for 30 minutes for a hydrogen implantation dose in the order of 6.10¹⁶H⁺/cm²) and mechanical-chemical polishing. One example of bonding forces which may be obtained is shown in the graphs in FIG. 5. For example, for SiO₂—SiO₂ bonding with a surface roughness of 6.25 A rms (AFM measurement on 1×1 μm analysed surfaces) for the two contacted surfaces, bonding energies in the order of 250 mJ/m² are obtained even after treatment at 800° C.

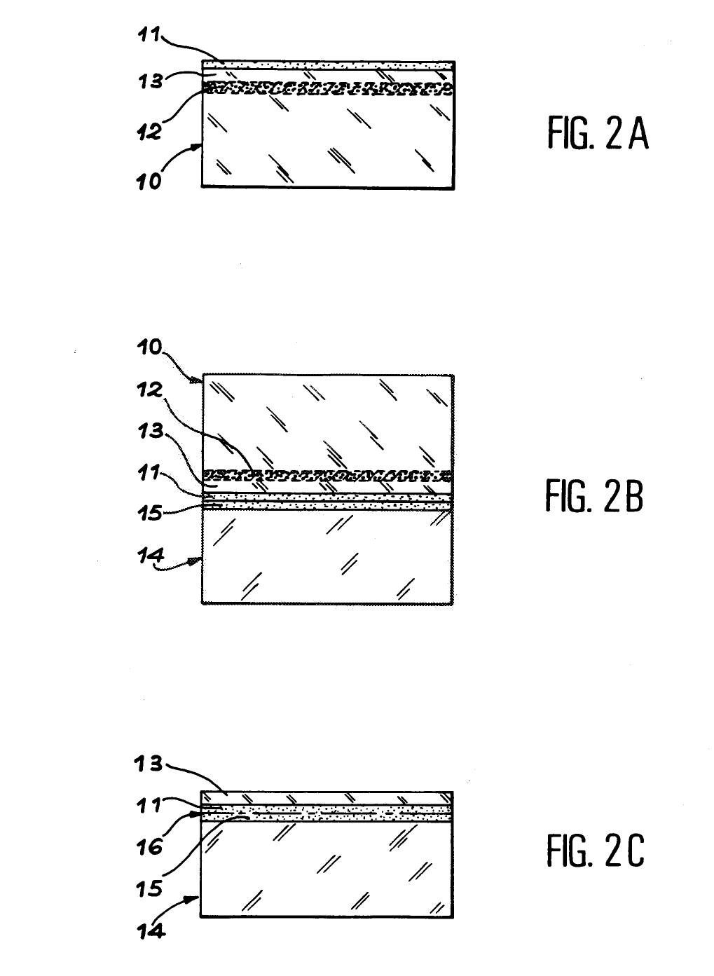

FIGS. 2A to 2C illustrate this example of embodiment. FIG. 2A shows, from side view, a substrate 10 in monocrystalline silicon of which one surface is coated with a very fine layer of silicon oxide 11. Via the oxide layer 11, hydrogen ions are implanted intended to induce a fracture zone. A layer of microcavities 12 is obtained determining, between itself and oxide layer 11, a very thin region 13 of silicon. FIG. 2B shows, also from side view, another silicon substrate 14 coated with a very thin layer of silicon oxide 15. Substrates 10 and 14 are made integral by molecular adhesion of their oxide layers 11 and 15. Subsequently, through appropriate heat treatment, the microcavities of layer 12 are caused to coalesce to obtain fracture and separation of substrate 10 into two parts. The free surface of region 13 is polished to form a thin layer intended for hetero-epitaxy (see FIG. 2C). Oxide layers 11 and 15 are joined by bonding interface 16.

It is to be specified that the thin film structure serving as seed/joining zone to the bonding interface/substrate may be obtained by other methods than the process described in document FR-A-2 681 472. By way of indication, methods may be cited which are based on bonding by molecular adhesion and thinning by grinding and polishing. It is also possible to use thin layers transferred by lift-off epitaxy. Numerous examples exist in the literature, in particular to obtain thin films of III-V materials, such as GaAs for example. It is also possible to have recourse to the use of a carrier handle to transfer the thin layers, used as seed, from their basic substrate to the structure which is to become compliant.

To control bonding forces it is also possible to make use of the number of bonding defects (that is to say non-bonded zones) present on this interface.

One of the solutions previously put forward, is to obtain bonding forces, between the thin film to be used as seed and the carrier, that are sufficiently low for the thin film to absorb stresses without however becoming detached.

One variant of this process consists of exploiting these bonding forces and the presence of intermediate layers; since these intermediate layers are able to reinforce the compliant nature of the structure. More precisely, consideration is given in this case, not only to the bonding forces between the seed film and the surface, but in order to accommodate stresses use is also made of the adhesion forces between the different layers and the very nature of the different thin layers.

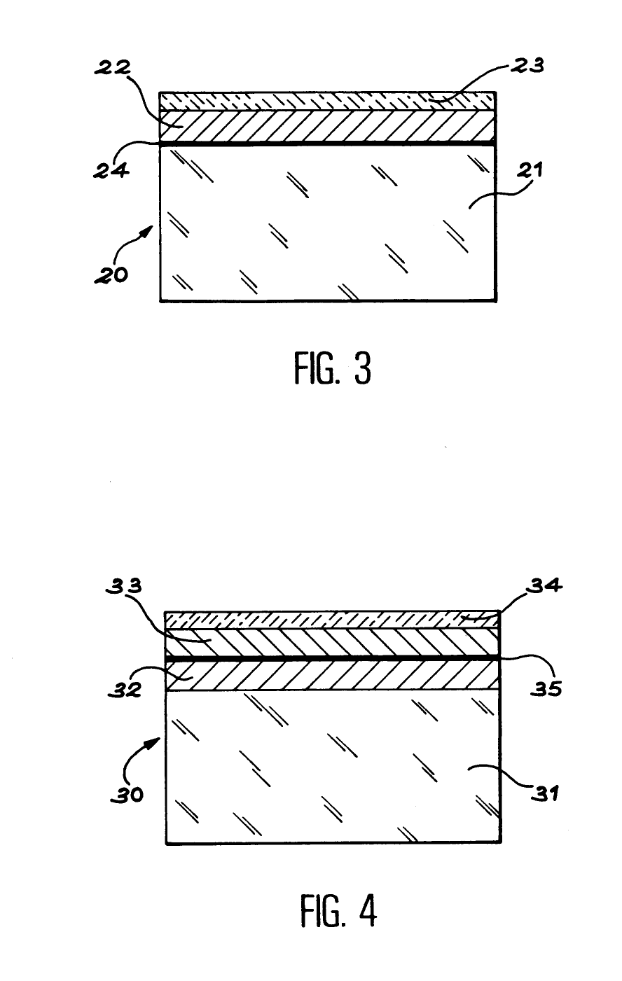

FIG. 3 shows, from side view, such compliant substrate. The compliant substrate 20 comprises a carrier 21, an intermediate layer 22 coated with a thin layer 23 intended to act as seed for hetero-epitaxy. The intermediate layer 22 is joined to carrier 21 via a bonding interface 24.

By way of example, for intermediate layer 22 a metal may be used whose mechanical properties (deformation) are such that it may absorb a large part of the stresses. For example, the process described in document FR-A-2 681 472 may be used to obtain the thin film 23 of semiconductor used for germination, but in order to make thin film 23 integral with intermediate layer 22 a metal compound is used containing Au (95%)-Sn (5%) or a compound containing Al (5%)-Cu (95%). These metal compounds have the property of being viscous over a wide temperature range compatible with the temperatures at which epitaxy is generally conducted (900-1000° C.). By way of example the use of Pd, Pt may be cited, or of silicides or metal alloys or metal-substrate alloys.

An intermediate layer may also cover the part of the substrate forming the carrier properly so called. This is shown in FIG. 4 in which the compliant substrate 30 comprises a carrier part 31 coated with a first intermediate layer 32, a second intermediate layer 33 and the thin layer used as seed 34. The bond interface 35 is then situated between the two intermediate layers 32 and 33. These intermediate layers may be of same or different type.

The fabrication of the intermediate layer on the thin film and optionally on the carrier substrate is made before transfer of the intermediate layer/thin film structure used as seed onto the carrier substrate. The intermediate layer is a solid of amorphous, polycrystalline or crystalline type. It may be formed of one or more sub-layers in a same material or a different material and/or be formed of one or more interfaces.

The fabrication of the intermediate layer on the adaptable thin film and optionally on the carrier substrate may be made:
either using conventional thin layer vacuum depositing techniques (evaporation, cathode spraying, CVD, MBE . . . ),
or by electrochemical depositing techniques (electrolysis, electroless, etc.),
or by thin layer transfer techniques: bonding by molecular adhesion then thinning, bonding then thinning using a process such as described in document FR-A-2 681 472, bonding the intermediate layer (already made into a thin layer) via a handle acting as carrier and removal of the handle,
or by conversion of a certain thickness from the surface. This conversion may, for example, be made by oxidation or nitriding. If oxidation is used, it may be either thermal, or anodic, or obtained using another technique (oxygen plasma, oxygen implantation, . . . ). Oxidation may also be conducted through the combination of several oxidation techniques.
using a method enabling the fabrication of a deformable porous layer.

In the fabrication of a compliant substrate, the thickness of the superficial film may be extremely critical. In some cases, it is necessary to be able to produce superficial films of very narrow thickness. Several methods may be used for the thinning of thin films. In non-exclusive manner the following may be cited: ion abrasion, chemical etching, plasma-assisted etching, laser-assisted ablation, the forming of a sacrificial layer (by oxidation, nitriding the superficial film . . . ) and removal of this sacrificial layer by various means.

In one application in which the thin layer acting as seed is a silicon film, this film may be the upper film of a silicon-on-insulator structure, made using the SIMOX technique or a molecular adhesion method, so-called wafer-bonding, for example such as the one described in document FR-A-2 681 472. In this case, the thickness of the silicon film before thinning is for example in the order of 0.2 μm. Heat treatment of this superficial silicon film at 1000° C. for 70 minutes under a steam atmosphere, leads to the formation of a film of silicon oxide approximately 0.4 μm thick. On this account, the superficial silicon film is thinned down to a narrow thickness in the order of 1 nm to a few dozen nm. Chemical removal of the silica film on the surface is made using 10% hydrofluoric acid for 10 minutes. This thinning step of the silicon film may advantageously be completed, for a very thin film of silicon, by heat treatment of the surface under a hydrogen atmosphere at high temperature. For example, a treatment at a temperature in the region of 1150° C. for 10 minutes enables crystalline reconstruction of the free silicon surface. At the same time, thinning of the silicon film of a few nanometres is evidenced.

In the approach to compliance, one of the principles is to permit relaxation of epitaxy-related stresses via the film or films of compliance. It may then be advantageous, before epitaxy, to induce a stress in the superficial film acting as seed, at room temperature, via modification of physical parameters, even chemical nature, depending upon the type and nature of depositing to be made. These modifications are made for the purpose of promoting subsequent relaxation of deposit stresses. By pre-stressing the material it is possible to promote the generation of dislocations in the superficial film or films of compliance or at the interfaces of these films.

In general, epitaxy is made at a temperature of several hundred degrees. The criterion of lattice adaptation does not therefore need to be taken into account at room temperature. It is important to assess the role of the stresses of thermal origin related, for example, to differences in thermal dilatation between the various films and the mechanical carrier (substrate).

In this optic, the fact may be used that it is possible to modify the crystalline parameter of the superficial film using implantation by bombardment of an element in the crystalline matrix of the superficial film, optionally supplemented by heat diffusion of the element. One variant of implantation by bombardment is to use the processes based solely on thermal diffusion of elements, such as the diffusion of doping agent in silicon. By way of example of ion implantation, mention may be made of boron implantation in monocrystalline silicon. This leads to a reduction in crystalline lattice of 0.014 Å/atom % of the species inserted. If the superficial film adheres strongly to the mechanical carrier, the silicon film will then be placed in a tensile state. In the same way, the effect of germanium implantation will be to increase the crystalline lattice by 0.0022 Å/atom %. If the superficial film adheres strongly to the mechanical carrier, the film of silicon will then be placed in a state of compression.

In the case of thin silicon films, made for compliance by thinning through sacrificial oxidation as described previously, implantation may advantageously be made before removal of the oxide. The film of oxide therefore acts as protective film during heat diffusion treatment of the implanted element. By way of example implantation of boron at an energy in the region of 110 keV, with a dose in the order of a few 10¹⁵/cm² to a few 10¹⁶ cm², via the oxide layer with a thickness close to 0.4 μm, leads to enriching the very thin silicon film with boron by coinciding the depth of this film with the depth of ion implantation. Stresses of a few 10⁸ MPa may hence be generated in the thin film of silicon.

1-24. (canceled)

25. Compliant substrate comprising a carrier and a structure comprising at least one thin layer, the structure being bonded on a surface of said carrier by molecular adhesion to constitute a bonding interface whose bonding energy is controlled to permit absorption, in whole or in part by the bonding interface, of stresses brought to said compliant substrate.

26. Compliant substrate according to claim 25, wherein said bonding interface is an interface resulting from a surface preparation and/or an interface resulting from a heat treatment and/or an interface resulting from a creation of defects.

27. Compliant substrate according to claim 26, wherein said surface preparation is a control of roughness and/or hydrophylia.

28. Compliant substrate according to claim 25 where said structure also comprises at least one intermediate layer between the thin layer and the carrier.

29. Compliant substrate according to claim 28, wherein the intermediate layer is a metal layer or metal alloy layer.

30. Compliant substrate according to claim 28, wherein said at least one intermediate layer is formed such that it comprises non-homogeneities.

31. Compliant substrate according to claim 25, wherein said stresses are brought by a hetero-epitaxial growth formed on the thin layer.

32. Compliant substrate according to claim 25, wherein the carrier comprises at least one intermediate layer joined to said carrier, the bonding interface being located between said structure and said at least one intermediate layer.

33. Compliant substrate comprising:
a carrier having a first thin layer; and
a structure comprising a second thin layer, the structure being bonded on the first thin layer of said carrier by molecular adhesion to form a bonding interface whose bonding energy is controlled to permit absorption, in whole or in part by the bonding interface, of stresses brought to said compliant substrate.
